(19) United States
(12) Patent Application Publication
(10) Pub. No.: US 2025/0293245 A1
(43) Pub. Date: Sep. 18, 2025

(54) COMPOSITE ACTIVE MATERIAL AND METHOD FOR PRODUCING COMPOSITE ACTIVE MATERIAL

(71) Applicant: TOYOTA JIDOSHA KABUSHIKI KAISHA, Toyota-shi (JP)

(72) Inventors: Heidyhodex VISBALMENDOZA, Toyota-shi (JP); Nobuki KYONO, Obu-shi (JP)

(73) Assignee: TOYOTA JIDOSHA KABUSHIKI KAISHA, Toyota-shi (JP)

(21) Appl. No.: 19/073,212

(22) Filed: Mar. 7, 2025

(30) Foreign Application Priority Data
Mar. 18, 2024 (JP) 2024-042690

(51) Int. Cl. H01M 4/36; H01M 4/62; H01M 10/0562

(52) U.S. Cl. CPC H01M 4/366; H01M 4/625; H01M 10/0562; H01M 2300/0071

(57) ABSTRACT

A main object of the present disclosure is to provide a composite active material capable of suppressing an increase in battery resistance. The present disclosure achieves the object by providing a composite active material comprising: an active material particle having a core particle and a first coating layer coating the core particle, and a second coating layer coating the active material particle, wherein the first coating layer contains a first solid electrolyte, the second coating layer contains a carbon-based conductive material and a second solid electrolyte, and in the active material particle, a ratio (conductive material coverage) of a part in contact with the carbon-based conductive material of the second coating layer is 0.9% or more and less than 5.0%.

### TECHNICAL FIELD

The present disclosure relates to a composite active material and a method for producing the composite active material.

### BACKGROUND ART

In recent years, battery has been actively developed. For example, the automotive industry is developing a battery for use in battery electric vehicle (BEV), plug-in hybrid vehicles (PHEV), or hybrid vehicles (HEV). In addition, members and materials used in battery are being developed.

For example, Patent Literature 1 discloses a composite active material including a composite particle including an oxide-based solid electrolyte that covers all or a part of a surface of an active material particle, and a sulfide based solid electrolyte that further covers 76.0% or more of the surface of the composite particle.

Patent Literature 2 also discloses a method for producing a cathode material comprising: a first mixing step mixing cathode active material and a conductive aid to produce a first powder; a second mixing step mixing a solid electrolyte and a conductive aid to produce a second powder; and a third mixing step mixing the first powder and the second powder to produce a third powder.

### CITATION LIST

### Patent Literature

Patent Literature 1: Japanese Patent Application Laid-Open (JP-A) No. 2014-154407

Patent Literature 2: JP-A No. 2023-150188

### SUMMARY OF DISCLOSURE

### Technical Problem

As described above in Patent Literature 1, a compound active material in which an active material is coated with solid electrolyte has been studied. Such a composite active material is expected to be effective in suppressing deterioration of the active material and suppressing increased battery resistance. On the other hand, there is room for further improvement in suppressing the increase of battery resistance.

The present disclosure has been made in view of the above circumstances, and an object of the present disclosure is to provide a composite active material capable of suppressing an increase in battery resistance.

### Solution to Problem

[1]

A composite active material comprising:
an active material particle having a core particle and a first coating layer coating the core particle, and
a second coating layer coating the active material particle, wherein
the first coating layer contains a first solid electrolyte,
the second coating layer contains a carbon-based conductive material and a second solid electrolyte, and
in the active material particle, a ratio (conductive material coverage) of a part in contact with the carbon-based conductive material of the second coating layer is 0.9% or more and less than 5.0%.
   [2]

The composite active material according to [1], wherein the first coating layer contains LiNbO₃ as the first solid electrolyte.

[3]

The composite active material according to [1] or [2], wherein the second coating layer contains a sulfide solid electrolyte as the second solid electrolyte.

[4]

The composite active material according to any one of [1] to [3], wherein in the active material particle, a ratio (solid electrolyte coverage) of a part in contact with the second solid electrolyte of the second coating layer is 95% or more and 99% or less.

[5]

A method for producing the composite active material according to any one of [1] to [4], the method comprising:
a first step preparing the active material particle; and
a second step subjecting a mixture comprising the active material particle, the second solid electrolyte and the carbon-based conductive material to a compressive shear treatment and obtaining the composite active material.

### Advantageous Effects of Disclosure

According to the present disclosure, it is possible to provide a compound active material capable of suppressing an increase in battery resistance.

### BRIEF DESCRIPTION OF DRAWINGS

FIG. 1 is a schematic cross-sectional view illustrating the composite active material in the present disclosure.

FIG. 2 is a flowchart illustrating the method for producing the composite active material in the present disclosure.

FIG. 3 is a SEM image of the composite active material obtained in Example 1.

FIG. 4 is a graph of the measurement result of conductive material coverage and resistance increase rate.

### DESCRIPTION OF EMBODIMENTS

Hereinafter, a composite active material and a method for producing the composite active material will be described.

### A. Composite Active Material

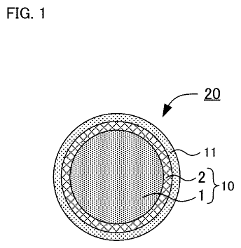

FIG. 1 is a schematic cross-sectional view illustrating a composite active material according to the present disclosure. Note that FIG. 1 schematically shows the composite active material in the present disclosure, and the size and shape of each part are appropriately exaggerated for ease of understanding. The composite active material 20 shown in FIG. 1 includes active material particles 10 having a first coating layer 2 that covers the core particles 1 and the core particles 1, and a second coating layer 11 that covers the active material particles 10. The first coating layer 2 contains a first solid electrolyte, and the second coating layer 11 contains a carbon-based conductive material and a second solid electrolyte. In addition, in the active material grains 10, the ratio of the part of the second coating layer 11 in contact with the carbon-based conductive material (the coating ratio of the conductive material) is 0.9% or more and less than 5.0%.

According to the present disclosure, since the composite active material has a predetermined first coating layer and a predetermined second coating layer, and the coating ratio of the conductive material is 0.9% or more and less than 5.0%, battery resistivity can be suppressed from increasing.

As described above, a composite active material having solid electrolyte layers formed thereon has been studied. On the other hand, in an electrode layer prepared by mixing such a composite active material with a conductive material, a composite active material (an active material having a sufficient electron conduction path) that is in good contact with the conductive material and a composite active material (an active material having an insufficient electron conduction path) that is not in good contact with the conductive material are mixed, and there is a possibility that reaction unevenness occurs in the electrode layer. In addition, there is a possibility that the electrode layers expand and contract due to charging and discharging of battery. In this regard, if the electron-conducting path of the active material locally reacting is cut along with the expansion and contraction of the electrode layers, battery resistivity may be greatly increased. In addition, in an active material that reacts locally, degradation of the active material may be accelerated, and battery resistivity may be increased. In contrast, in the composite active material according to the present disclosure, the second coating layer including the second solid electrolyte and the carbon-based conductive material is formed on the surface of the active material particles. Therefore, in the electrode manufactured using such a composite active material, the proportion of the composite active material having a sufficient electron conduction path can be increased. As a result, the reaction unevenness can be suppressed. Further, the conductive material coating ratio is 0.9% or more, since it is less than 5.0%, it is presumed that the balance between the electron conduction path and the ion conduction path in the composite active material is good. It is presumed that, due to these factors, battery resistivity of the composite active material can be suppressed from increasing.

### 1. Active Material Particle

The active material particle has a core particle and a first coating layer coating the core particle.

### (1) Core Particle

The core particle is not particularly limited as long as it is an active material commonly used in battery. Examples of the core particles include an oxide active material and a metal active material. Examples of the oxide active material include rock salt layered active materials such as LiNi_{1/3}Co_{1/3}Mn_{1/3}O₂ and LiNi_{0.&}Co_{0.15}Al_{0.05}O₂, spinel-type active materials such as LiMn₂O₄ and lithium titanate, and olivine-type active materials such as LiFePO₄. Examples of the oxide active material include SiO₂. Examples of the metal active material include elemental metals such as Si, and alloys.

Average particle size D₅₀ of the core-particle may be, for example, equal to or greater than 100 nm, equal to or greater than 1 μm, or equal to or greater than 5 μm. On the other hand, average particle size D₅₀ of the core-particle may be, for example, 50 μm or less and 20 μm or less. D₅₀ refers to the cumulative 50% particle size in a volume-based particle size distribution by a laser diffractive particle size distribution analyzer. The core particles may be primary particles or secondary particles in which primary particles are aggregated.

### (2) First Coating Layer

The first coating layer is a layer that covers the above-described core-particle and contains the first solid electrolyte.

Examples of the first solid electrolyte include lithium-ion conductive oxides such as LiNbO₃, Li₄Ti₅O and Li₃PO₄. Of these, LiNbO₃ is preferable.

The ratio of the first solid electrolyte in the first coating layer is not particularly limited, but is, for example, 90 wt % or more and 100 wt % or less. Here, the first coating layer may or may not contain a conductive material.

The coverage by the first coating layer is not particularly limited, but may be, for example, 50% or more, 60% or more, or 75% or more. On the other hand, the coverage may be 100% or less than 100%. The coverage may be 95% or less, 90% or less, or 80% or less. The coverage can be determined, for example, by scanning-electron microscopy (SEM).

The thickness of the first coating layer is not particularly limited, but is, for example, greater than or equal to 1 nm and less than or equal to 100 nm. The thickness of the first coating layer can be obtained from, for example, cross-sectional SEM images.

### (3) Active Material Particle

Average particle size (D₅₀) of the active material grains is not particularly limited, but is, for example, not less than 100 nm and not more than 50 micrometers. D₅₀ is as described above.

### 2. Second Coating Layer

The second coating layer is a layer for coating the active material particles described above, and includes a carbon-based conductive material and a second solid electrolyte.

Examples of the carbon-based conductive material include particulate carbon such as acetylene black (AB) and Ketjen black (KB); and fibrous carbon such as carbon fiber (CF), carbon nanotube (CNT), and carbon nanofiber (CNF).

The ratio of the carbon-based conductive material in the second coating layer is not particularly limited, but is, for example, 2 wt % or more and 10 wt % or less.

In the present disclosure, a ratio of a part of the active material particles that is in contact with the carbon-based conductive material in the second coating layer is referred to as a conductive material coating ratio. The conductive material coating ratio is 0.9% or more, less than 5.08. The coating ratio of the conductive material may be 1.0% or more, or 2.0% or more. On the other hand, the coating ratio of the conductive material may be 4.9% or less, 4.0% or less, or 3.0% or less. Conductive material coverage can be calculated by SEM (Scanning Electron Microscopy) observations. More specifically, the methods described in the Examples are included.

The second solid electrolyte is usually an electrolyte in which the main components of the first solid electrolyte and the anionic element differ from each other. Examples of the second solid electrolyte include inorganic solid electrolyte such as sulfide solid electrolyte, oxide solid electrolyte, nitride solid electrolyte, halide solid electrolyte, and complex hydride. Among them, sulfide solid electrolyte is particularly preferable. This is because the ion conductivity is high. sulfide solid electrolyte usually contains sulphur(S) as the main component of the anionic element. The oxide solid electrolyte, the nitride solid electrolyte, and the halide solid electrolyte usually contain oxygen (O), nitrogen (N), and halogen (X) as main components of the anionic element, respectively.

Sulfide solid electrolyte preferably contains, for example, an Li element, an X element (X is at least one of P, As, Sb, Si, Ge, Sn, B, and Al, Ga, In), and an S element. sulfide solid electrolyte may further contain at least one of an O element and a halogen element.

Examples of sulfide solid electrolyte include Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers, Z is any of Ge, Zn, Ga), and Li₂S—GeS₂, Li₂S—SiS₂—Li₃PO₄, Li₂S—SiS₂—LiₓMO_{y} (where x and y are positive numbers, and M is any of P, Si, Ge, B, and Al, Ga, In).

Sulfide solid electrolyte may be glass (amorphous) or glass ceramic.

The ratio of the second solid electrolyte in the second coating layer is not particularly limited, but is, for example, 90 wt % or more and 98 wt % or less.

Here, in the active material grains, a ratio of a part of the second coating layer in contact with the second solid electrolyte is defined as a solid electrolyte coverage. solid electrolyte coverage is not particularly limited, but may be, for example, 75% or more, 90% or more, 95% or more, 96% or more, or 97% or more. On the other hand, solid electrolyte coverage is, for example, 99% or less. The method of calculating solid electrolyte coverage can be the same as the method of calculating the conductive material coverage described above.

The thickness of the second coating layer is not particularly limited, but is, for example, 0.1 μm or more and 10 μm or less. The thickness of the second coating layer can be obtained from, for example, cross-sectional SEM images.

The second coating layer may be formed on a part or the entire surface of the first grains. The coverage ratio of the second coating layer is not particularly limited, but is, for example, 75% or more and 100% or less. Here, the surface of the first particle can be regarded as the surface of the first coating layer and the surface of the core particle on which the first coating layer is not formed. The second coating layer may be formed on the surface of the core particle as long as it is formed on at least the surface of the first coating layer in the first particle. In other words, the second coating layer may be formed on the surface of the core-particle not coated with the first coating layer.

### 3. Composite Active Material

The composite active material is typically in the form of particles. average particle size (D₅₀) of the complex active material is, for example, 1 μm or more and 50 μm or less.

Composite active materials are commonly used in battery. In particular, the composite active material is preferably used for all solid-state battery. The complex active material may be used as a cathode active material in a battery, or may be used as an anode active material. The materials and configurations of battery may be known materials and configurations.

### B. Method for Producing a Composite Active Material

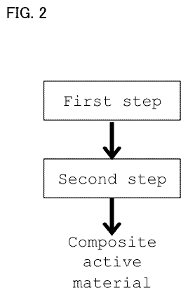

FIG. 2 is a flowchart illustrating a method for producing of a complex active material according to an embodiment of the present disclosure. As shown in FIG. 2, first, active material particles having a core particle and a first coating layer for coating the core particle are prepared (first step). Next, the active material particles, the second solid electrolyte, and the carbon-based conductive material are subjected to a compressive shear treatment to obtain the composite active material (second step).

According to the present disclosure, it is possible to produce a composite active material in which the second coating layer is formed on the surface of the active material particles and exhibits the above-described conductivity of the conductive material coating by subjecting the mixture comprising the active material particles, the second solid electrolyte, and the carbon-based conductive material to a compressive shear treatment.

### 1. First Step

The first step is a step of preparing the active material particles described above. The active material grains are the same as those described in the “A. complex active material”.

The active material particles can be prepared by forming the first coating layer on the surface of the core particles using, for example, a sol-gel method and a spray-drying method. In the sol-gel method, for example, active material particles can be obtained by spray-coating a composition including a raw material of the first solid electrolyte and a dispersing medium on the surface of the core particles using a rolling flow coating device, and then baking the coating material particles. As the spray drying method, the method described in Examples described later can be exemplified.

### 2. Second Step

The second step is a step of subjecting the active material particles, the second solid electrolyte, and the carbon-based conductive material to a compressive shear treatment to obtain the composite active material. The second solid electrolyte and the carbon-based conductive material are the same as those described in the “A. complex active material”.

The ratio of the active material particles, the second solid electrolyte and the carbon-based conductive material in the mixture is appropriately adjusted so as to obtain the above-described conductive material coating ratio and solid electrolyte coating ratio.

Compressive shear treatment includes a method in which the mixture is charged into a container, mixed using a crushing medium such as blades, beads, and balls, to impart compressive shear energy to the mixture present between the mixture and the wall surface of the container. The compressive shear is appropriately adjusted so that the above-described second coating layer is formed.

### 3. Composite Active Material

The composite active material produced in the above- described process is the same as the content described in the “A. composite active material”.

Note that the present disclosure is not limited to the above-described embodiment. The above-described embodiment is an example, and any one having substantially the same configuration as the technical idea described in the claims in the present disclosure and having the same operation and effect is included in the technical scope of the present disclosure.

### EXAMPLES

### Example 1

### (Preparation of Composite Active Material)

First, the active material particles were obtained by coating the surface of the core particles (LiNi_{1/3}Co_{1/3}Mn_{1/3}O₂) with lithium niobate (LiNbO₃) using a spray-drying method.

Specifically, hydrogen peroxide water (mass density: 30%), ion-exchanged water, and niobate (Nb₂O₅·3H₂O) were placed in a container, and ammonia water (mass concentration: 28%) was charged into the container and stirred. Then, lithium hydroxide monohydrate (LiOH·H₂O) was further added and dissolved. Thus, a coating liquid was prepared.

The core particles and the coating liquid were mixed to prepare a suspension. The suspension was dried using a BUCHI spray dryer (Mini Spray Dryer B-290) to give a solid content. Then, the solid component was heat-treated at 200° C. for 5 hours. As a result, the core particles (active material particles) coated with LiNbO₃ were obtained.

Next, the active material particles, sulfide solid electrolyte (LiI—Li₂S—P₂S₅; glass ceramics), and the carbon-based conductive material (carbon black) were mixed with a dry particle compounding device (Nobilta) manufactured by Hosokawa Micron Co., Ltd., while applying a shearing force (compression shearing treatment). As a result, a composite active material in which a second coating layer including sulfide solid electrolyte and carbon black was formed was obtained.

### (Production of Evaluation Battery)

The composite active material, a sulfide solid electrolyte (LiI—Li₂S—P₂S₅; glass ceramic), a binder (styrene-butadiene rubber: SBR), a conductive material (carbon nanotube), and a dispersing medium (1,2,3,4-tetrahydronaphthalene) were mixed to obtain a cathode slurry. In cathode slurry, the ratio of the complex active material, sulfide solid electrolyte, the binder, and the conductive material was set to be a weight-ratio of 81.2:16.5:0.3:1.9. cathode slurry was applied to a cathode current collector (Al foil) and dried to obtain a cathode having cathode active material layers and cathode current collector.

Anode active material (Li₄Ti₅O₁₂), sulfide solid electrolyte (LiI—Li₂S—P₂S₅; glass ceramic), a binder (SBR), a conductive material (carbon nanotube), and a dispersing medium (diisobutyl ketone) were mixed to obtain an anode slurry. In anode slurry, the ratio of anode active material, sulfide solid electrolyte, binder, and conductive material was defined as a weight-ratio of 72.2:24.3:1.8:2.4. anode slurry was applied to an anode current collector (Cu foil) and dried to obtain an anode having anode active material layers and anode current collector. anode size was adjusted to be larger than cathode size.

Sulfide solid electrolyte (LiI—Li₂S—P₂S₅; glass ceramic), a binder (acrylate butadiene rubber: ABR), and a dispersing medium (n-heptane, butyl butyrate) were mixed to obtain a slurry. The slurry was applied to a substrate (Al foil) and dried to obtain a transfer member having solid electrolyte layers. The size of solid electrolyte layers was the same as the size of anode.

Anode and the transfer member were pressed on top of each other so that anode active material and solid electrolyte layers were opposed to each other. solid electrolyte layers were then transferred by peeling off substrate. Further, cathode was pressed so that solid electrolyte layers and cathode active material layers were opposed to each other. The terminals were then mounted and constrained to 5 MPa pressure-to-electrode area. This gave a battery (all solid-state battery) for assessment.

### Example 2

Composite active materials and battery for assessment were prepared in the same manner as in Example 1, except that the ratio of active material particles, sulfide solid electrolyte, and carbon-based conductive material was changed as shown in Table 1 in the compressive shear treatment.

TABLE 1

| | Weight-ratio (wt % ) | | |
|---|---|---|---|
| | Active | | Carbon-based |
| | material | Sulfide solid | conductive |
| | particle | electrolyte | material |
| Example 1 | 93.44 | 6.32 | 0.23 |
| Example 2 | 93.23 | 6.31 | 0.47 |

### Comparative Example 1

A battery for evaluating was prepared in the same manner as in Example 1, except that cathode was prepared using the active material grains described above instead of the complex active material.

### Comparative Example 2

The active material particles and sulfide solid electrolyte (LiI—Li₂S—P₂S₅; glass ceramics) were mixed by a dry particle compounding device (Nobilta) manufactured by Hosokawa Micron Co., Ltd., while applying a shearing force. As a result, a composite particle was obtained in which the second coating layer having no carbon-based conductive material was formed on the active material particles. A battery for evaluating was prepared in the same manner as in Example 1, except that cathode was prepared using the composite-particle.

### Comparative Example 3

The active material particles and the carbon-based conductive material (carbon nanotubes) were mixed by a dry particle compounding device (Nobilta) manufactured by Hosokawa Micron Co., Ltd. while applying a shearing force. As a result, a composite particle in which the second coating layer having no sulfide solid electrolyte was formed on the active material particles was obtained. A battery for evaluating was prepared in the same manner as in Example 1, except that cathode was prepared using the composite-particle.

### [Evaluation]

### (Surface Observation of Composite Active Material)

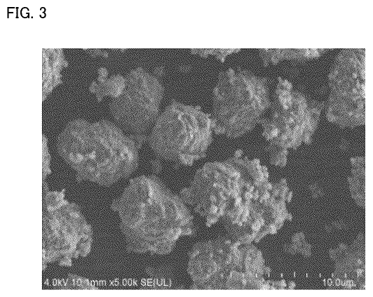

The composite active material of Example 1 was subjected to SEM observations and EDX analyses, and then subjected to surface-observation. SEM images are shown in FIG. 3. As shown in FIG. 3, it was confirmed that sulfide solid electrolyte was disposed on the surface of the complex active material. In addition, it was confirmed from EDX analyses that the carbon element derived from the carbon conductive material was disposed on the surface of the composite active material.

### (Measure of Coverage)

Surface SEM images were taken of the composite active materials of Examples 1 to 2 and Comparative Example 3. From the obtained image, a binarized image of the portion coated with the conductive material and the non-coated portion was generated. The binarized image was created using image analysis software “ImageJ”. Then, the area of the covered portion and the area of the uncoated portion in the image were determined by image analysis software. Using these values, the conductive material coverage was calculated by the following formula. The results are shown in Table 2. In the following formula, the area of the coated part+the uncoated part means the area of the entire active material particle. In the same manner, the percentage (solid electrolyte coverage) of the part coated with sulfide solid electrolyte was calculated for the composite active materials of Examples 1 to 2. The results are shown in Table 2.

$$[ Formula 1 ]$$

$$\text{Conductive material coverage (\%)} = \frac{\text{Area of covered part} ( {µm}^{2} )}{\text{Area of covered part} + \text{uncovered part} ( {µm}^{2} )} \times 100$$

### (Charge/Discharge Evaluation: Cycle Test)

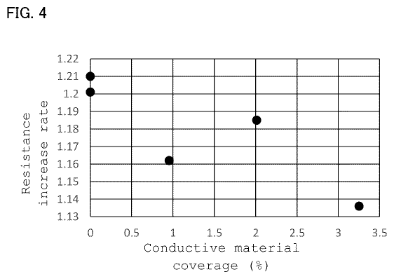

Battery obtained in Examples 1 to 2 and Comparative Examples 1 to 3 were CCCV charged with 1/3 C at 25° C. to 2.95V, and then CCCV discharged with 1/3 C to 1.5V at 25° C. to activate them. The cycle test was performed on the activated battery from 1.5V under 2.95V voltage-range, 60° C., and 1C conditions, and the resistance increase rate (the increase rate of the resistance value after the cycle test with respect to the resistance value before the cycle test) was calculated from the resistance values before and after the cycle test. The results are shown in Table 2. For resistance, the 5 second discharge resistance was measured for battery adjusted to SOC20%. Specifically, the voltage variation ΔV value when the current value of 2.5C rate was passed at 25° C. was read, and the resistance value was calculated by Ohm's law (V=IR). The results of the conductive material coating rate and the resistivity increase rate are summarized in FIG. 4. Incidentally, in FIG. 4, the conductive material coverage of Comparative Examples 1 and 2 is shown as 0%.

### (Measure of Electronic Conductivity)

Further, the electronic conductivity was measured with respect to cathode prepared in Examples 1 to 2 and Comparative Example 1. The results are shown in Table 2.

TABLE 2

| | Composition | | | Electronic | |
|---|---|---|---|---|---|
| | of the second | Coverage (%) | | conductivity | Resistance |
| | coating | Conductive | Solid | of cathode | increase rate |
| | layer | material | electrolyte | (S/cm) | (magnification) |
| Comp. Ex. 1 | — | — | — | 0.0145 | 1.201 |
| Comp. Ex. 2 | Sulfide | — | — | — | 1.210 |
| | solid | | | | |
| | electrolyte | | | | |
| Comp. Ex. 3 | Carbon-based | 2.012 | — | — | 1.185 |
| | conductive | | | | |
| | material | | | | |
| Example 1 | Sulfide | 0.953 | 98.9 | 0.0202 | 1.162 |
| | solid | | | | |
| | electrolyte | | | | |
| | Carbon-based | | | | |
| | conductive | | | | |
| | material | | | | |
| Example 2 | Sulfide | 3.251 | 95.3 | 0.0347 | 1.136 |
| | solid | | | | |
| | electrolyte | | | | |
| | Carbon-based | | | | |
| | conductive | | | | |
| | material | | | | |

As shown in Table 2 and FIG. 4, it was confirmed that the resistance increase rate was smaller in all of the Examples than in the Comparative Examples, and the increase in battery resistance was suppressed. Further, in Comparative Example 3, although the conductive material coating ratio is higher, since sulfide solid electrolyte is not present in the second coating layer, it is considered that a good interface is not formed between the complex active material and the electrolyte in cathode active material layers, and the resistivity is increased. Although solid electrolyte coverage of the composite active material of Comparative Example 2 is not calculated, it is presumed that the coverage is higher than solid electrolyte coverage of Examples 1 to 2.

### REFERENCE SINGS LIST

1 core particle
2 first coating layer
10 active material particle
11 second coating layer
20 composite active material

What is claimed is:

1. A composite active material comprising:
an active material particle having a core particle and a first coating layer coating the core particle, and
a second coating layer coating the active material particle, wherein
the first coating layer contains a first solid electrolyte,
the second coating layer contains a carbon-based conductive material and a second solid electrolyte, and
in the active material particle, a ratio (conductive material coverage) of a part in contact with the carbon-based conductive material of the second coating layer is 0.9% or more and less than 5.0%.

2. The composite active material according to claim 1, wherein the first coating layer contains LiNbO3 as the first solid electrolyte.

3. The composite active material according to claim 1, wherein the second coating layer contains a sulfide solid electrolyte as the second solid electrolyte.

4. The composite active material according to claim 1, wherein in the active material particle, a ratio (solid electrolyte coverage) of a part in contact with the second solid electrolyte of the second coating layer is 95% or more and 99% or less.

5. A method for producing the composite active material according to claim 1, the method comprising:
a first step preparing the active material particle; and
a second step subjecting a mixture comprising the active material particle, the second solid electrolyte and the carbon-based conductive material to a compressive shear treatment and obtaining the composite active material.
